(19) United States
(12) Patent Application Publication
(10) Pub. No.: US 2009/0162659 A1
(43) Pub. Date: Jun. 25, 2009

(54) Hydrophobin as a coating agent for expandable or expanded thermoplastic polymer particles

(75) Inventors: Christian Exner, Neustadt (DE); Ulf Baus, Dossenheim (DE); Jan Holoch, Leimen (DE); Claus Bollschweiler, Heidelberg (DE); Thomas Subkowski, Ladenburg (DE); Marvin Karos, Schwetzingen (DE); Hans-Georg Lemaire, Limburgerhof (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/921,924

(22) PCT Filed: Jun. 9, 2006
(86) PCT No.: PCT/EP2006/063037

§ 371 Date: Dec. 7, 2007

(30) Foreign Application Priority Data
Jun. 10, 2005 (DE) 102005027039.5

(51) Int. Cl. B32B 5/16; B05D 7/00

(52) U.S. Cl. 428/407; 427/222

(57) ABSTRACT

Expandable or expanded, thermoplastic polymer particles with a coating comprising hydrophobin, in particular proteins of the general structural formula (I)

Xₙ-C¹-X₁₋₅₀-C²-X₀₋₅-C³-X₁₋₁₀₀-C⁴-X₁₋₁₀₀-C⁵-X₁₋₅₀-C⁶-X₀₋₅-C⁷-X₁₋₅₀-C⁸-Xₘ (I)
where X is any of the 20 naturally occurring amino acids,
n and m are numbers between 0 and 500,
C is cysteine,
and their use as antistatics.

The invention relates to expandable or expanded, thermoplastic polymer particles with a coating comprising hydrophobin and to processes for the preparation thereof.

In order to enable expandable polystyrene to be transported in a trouble-free manner and to reduce electrostatic charge on the prefoamed polystyrene foam particles, the EPS particles are usually coated with an antistatic. Unsatisfactory antistatic properties are frequently caused by the coating agent being abraded or washed off the surface of the particles. The antistatic coating may also result in caking of the particles and poor flowing performance.

EP-A 470 455 describes bead-like antistatic expandable styrene polymers with a coating comprising a quaternary ammonium salt and finely divided silica, which are distinguished by good flowing performance.

Hydrophobins are small proteins of from about 100 to 150 amino acids, which are characteristic for filamentous fungi, for example Schizophyllum commune. They most usually have 8 cysteine units.

Hydrophobins have a marked affinity for interfaces and are therefore suitable for coating surfaces. Thus it is possible to coat, for example, Teflon by means of hydrophobins to obtain a hydrophilic surface.

Hydrophobins may be isolated from natural substances. Our previous application, DE 102005007480.4, discloses a process for preparing hydrophobins.

The use of hydrophobins for various applications has been proposed in the prior art.

WO 96/41882 proposes the use of hydrophobins as emulsifiers, thickeners, surfactants, for hydrophilizing hydrophobic surfaces, for improving the water resistance of hydrophilic substrates, for preparing oil-in-water emulsions or water-in-oil emulsions. Pharmaceutical applications such as the preparation of ointments or creams and also cosmetic applications such as skin protection or the preparation of hair shampoos or hair rinses are also proposed.

WO 01/57528 discloses the coating of windows, contact lenses, biosensors, medical apparatus, containers for carrying out experiments or for storage, ship hulls, solid particles or the chassis or bodywork of passenger vehicles with a hydrophobin-containing solution at a temperature from 30 to 80° C.

WO 03/53383 discloses the use of hydrophobin for treating keratin materials in cosmetic applications.

WO 03/10331 discloses a hydrophobin-coated sensor, for example a measuring electrode, to which further noncovalent substances, for example electroactive substances, antibodies or enzymes, have been attached.

It was therefore an object of the invention to remove the disadvantages mentioned and to find an antistatic coating agent for expandable or expanded, thermoplastic polymer particles, which has a reduced tendency of particles caking during prefoaming or foaming to give lower densities.

Accordingly, the expandable or expanded, thermoplastic polymer particles mentioned above were found.

The coating preferably comprises from 1 to 5000 ppm, in particular 10 to 1000 ppm, of hydrophobin, based on the thermoplastic polymer. The coating may comprise further antistatics and/or coating assistants or may be applied to further coatings containing different coating agents. Particular preference is given to a coating which consists only of hydrophobin or hydrophobin mixtures and forms a monomolecular layer on the expandable or expanded thermoplastic polymer particles.

Preference is given to using for the expandable or expanded, thermoplastic polymer particles styrene polymers such as polystyrene (EPS) or polyolefins such as polyethylene (EPE) or polypropylene (EPP).

Expandable thermoplastic polymer particles are those which can be foamed, for example by means of hot air or steam, to give expanded, thermoplastic polymer particles. They normally comprise chemical or physical blowing agents in amounts of from 2 to 10% by weight, preferably 3 to 7% by weight, based on the thermoplastic polymer.

Preferred physical blowing agents are gases such as nitrogen or carbon dioxide or aliphatic hydrocarbons having from 2 to 7 carbon atoms, alcohols, ketones, ethers or halogenated hydrocarbons. Particular preference is given to employing isobutane, n-butane, isopentane, n-pentane, neopentane, hexane or mixtures thereof.

The expandable and expanded thermoplastic polymer particles may further comprise effective amounts of customary assistants such as dyes, pigments, fillers, IR absorbers such as carbon black, aluminum or graphite, stabilizers, flame retardants such as hexabromocyclododecane (HBCD), synergistic flame retardants such as dicumyl or dicumyl peroxide, nucleating agents or glidants.

Depending on the manufacturing process, the expandable thermoplastic polymer particles according to the invention may be spherical, bead-shaped or cylindrical and normally have an average particle diameter in the range of 0.05 to 5 mm, in particular 0.3 to 2.5 mm and, if appropriate, may be divided into individual fractions by screening.

The expanded thermoplastic polymer particles have average particle diameters in the range of 1 to 10 mm, in particular 2 to 6 mm, and a density in the range of 10 to 200 kg/m³, corresponding to the degree of expansion.

The expandable thermoplastic polymer particles may be obtained, for example, by pressure impregnation of thermoplastic polymer particles with blowing agents in a tank, by suspension polymerization in the presence of blowing agents or by melt impregnation in an extruder or static mixer and subsequent underwater pressure granulation.

Expanded thermoplastic polymer particles may be obtained by foaming of expandable thermoplastic polymer particles, using, for example, hot air or steam in pressure prefoamers, by pressure impregnation of thermoplastic polymer particles with blowing agents in a tank and subsequent pressure reduction, or by melt extrusion of a blowing agent-containing melt with foaming up and subsequent granulation.

The term “hydrophobins” in accordance with the present invention means hereinbelow proteins of the general structural formula (I)

Xₙ-C¹-X₁₋₅₀-C²-X₀₋₅-C³-X₁₋₁₀₀-C⁴-X₁₋₁₀₀-C⁵-X₁₋₅₀-C⁶-X₀₋₅-C⁷-X₁₋₅₀-C⁸-Xₘ (I),

where X may be any of the 20 naturally occurring amino acids (Phe, Leu, Ser, Tyr, Cys, Trp, Pro, His, Gln, Arg, Ile, Met, Thr, Asn, Lys, Val, Ala, Asp, Glu, Gly). X may also in each case be identical or different. The indices next to X indicate in each case the number of amino acids, C is cysteine and the indices n and m are independently of one another natural numbers from 0 to 500, preferably from 15 to 300.

The polypeptides according to formula (I) are furthermore characterized by the property of their increasing, at room temperature, after coating of a glass surface, the contact angle of a water drop by at least 20°, preferably at least 25° and particularly preferably 30°, in each case compared to the contact angle of a water drop of the same size with the uncoated glass surface.

The cysteines denoted C¹ to C⁸ may either be in a reduced state or may form disulfide bridges between each other. Particular preference is given to the intramolecular formation of C-C bridges, in particular that with at least one, preferably 2, particularly preferably 3 and very particularly preferably 4, intramolecular disulfide bridges.

Preference is given to employing hydrophobins of the general formula (II)

Xₙ-C¹-X₃₋₂₅-C²-X₀₋₂-C³-X₅₋₅₀-C⁴-X₂₋₃₅-C⁵-X₂₋₁₅-C⁶-X₀₋₂-C⁷-X₃₋₃₅-C⁸-Xₘ (II),

to carry out the present invention, wherein X, C and the indices next to X and C are as defined above, the indices n and m are however numbers between 0 and 300 and the proteins are furthermore distinguished by the abovementioned contact angle change.

Particular preference is given to employing hydrophobins of the formula (III)

Xₙ-C¹-X₅₋₉-C²-C³-X₁₁₋₃₉-C⁴-X₂₋₂₃-C⁵-X₅₋₉-C⁶-C⁷-X₆₋₁₈-C⁸-Xₘ (III),

wherein X, C and the indices next to X and C are as defined above, the indices n and m are numbers between 0 and 200 and the proteins are furthermore distinguished by the abovementioned contact angle change.

The residues Xₙ and Xₘ may be peptide sequences which are naturally linked to a hydrophobin. However, either or both residues may also be peptide sequences which are not naturally linked to a hydrophobin. This also includes those residues Xₙ and/or Xₘ in which a peptide sequence naturally occurring in a hydrophobin has been extended by a peptide sequence which does not naturally occur in a hydrophobin.

If Xₙ and/or Xₘ are peptide sequences which are not naturally linked to hydrophobins, such sequences are usually at least 20, preferably at least 35, particularly preferably at least 50 and very particularly preferably at least 100, amino acids in length. A residue of this kind which is not naturally linked to a hydrophobin will also be referred to as fusion partner hereinbelow. This is intended to express the fact that the proteins may consist of at least one hydrophobin part and a fusion partner which in nature do not occur together in this form.

The fusion partner may be selected from a multiplicity of proteins. It is also possible for a plurality of fusion partners to be linked to one hydrophobin part, for example to the amino terminus (Xₙ) and to the carboxy terminus (Xₘ) of said hydrophobin part. However, it is also possible to link, for example, two fusion partner parts to one position (Xₙ or Xₘ) of the protein of the invention.

Particularly suitable fusion partner parts are proteins which occur naturally in microorganisms, in particular in E. coli or Bacillus subtilis. Examples of such fusion partner parts are the sequences yaad (SEQ ID NO:15 and 16), yaae (SEQ ID NO: 17 and 18), and thioredoxin. Fragments or derivatives of said sequences, which comprise only a part, preferably 70-99%, particularly preferably 80-98%, of said sequences or in which individual amino acids or nucleotides have been altered compared to the sequence mentioned, are also well suited, with the percentages referring in each case to the number of amino acids.

It is furthermore also possible that the polypeptide sequence of the proteins used according to the invention has been modified, for example by glycosylation, acetylation or else by chemical crosslinking, for example with glutaraldehyde.

One characteristic of the proteins used according to the invention is the change in surface properties when the surfaces are coated with said proteins. The change in surface properties can be determined experimentally by measuring the contact angle of a water drop before and after coating of the surface with the protein and determining the difference of the two measurements.

The measurement of contact angles is known in principle to the skilled worker. The measurements are based on room temperature and droplets of 5 l of water. The precise experimental conditions for a method of measuring the contact angle, which is suitable by way of example, are illustrated in the experimental section. Under the conditions mentioned there, the proteins used according to the invention have the property of increasing the contact angle by at least 20°, preferably at least 25°, particularly preferably at least 30°, in each case compared to the contact angle of a water drop of the same size with the uncoated glass surface.

The positions of the polar and nonpolar amino acids in the hydrophobin part of the hydrophobins known to date are preserved, resulting in a characteristic hydrophobicity plot. Differences in biophysical properties and hydrophobicity resulted in the classification of the hydrophobins known to date into two classes, I and II (Wessels et al. 1994, Ann. Rev. Phytopathol., 32, 413-437).

The assembled membranes of class I hydrophobins are to a large extent insoluble (even to 1% sodium dodecyl sulfate (SDS) at an elevated temperature) and can only be dissociated again by means of concentrated trifluoroacetic acid (TFA) or formic acid. In contrast, the assembled forms of class II hydrophobins are less stable. They may be dissolved again even by 60% strength ethanol or 1% SDS (at room temperature).

Comparison of the amino acid sequences reveals that the length of the region between cysteine C³ and C⁴ is distinctly shorter in class II hydrophobins than in class I hydrophobins. Class II hydrophobins furthermore have more charged amino acids than class I.

Hydrophobins which are particularly preferred for carrying out the present invention are those of types dewA, rodA, hypA, hypB, sc3, basf1, basf2 which are structurally characterized in the sequence listing below. They may also be only parts or derivatives of said types. It is also possible to link a plurality of hydrophobin parts, preferably 2 or 3, of the same or a different structure to one another and to a corresponding suitable polypeptide sequence which is not naturally connected to a hydrophobin.

Particularly suitable for carrying out the present invention are furthermore the fusion proteins having the polypeptide sequences indicated in SEQ ID NO: 20, 22, 24 and also the nucleic acid sequences coding therefor, in particular the sequences according to SEQ ID NO: 19, 21, 23. Particularly preferred embodiments are also proteins which, starting from the polypeptide sequences indicated in SEQ ID NO. 22, 22 or 24, result from the substitution, insertion or deletion of at least one, up to 10, preferably 5, particularly preferably 5% of all, amino acids and which still have at least 50% of the biological property of the starting proteins. Biological property of the proteins here means the above-described increase in the contact angle by at least 20°.

The proteins used according to the invention can be prepared chemically by known processes of peptide synthesis, for example by solid phase synthesis according to Merrifield.

Naturally occurring hydrophobins can be isolated from natural sources by means of suitable methods. By way of example, reference is made to Wösten et. al., Eur. J Cell Bio. 63, 122-129 (1994) or WO 96/41882.

Fusion proteins may preferably be prepared by genetic engineering processes in which one nucleic acid sequence, in particular DNA sequence, coding for the fusion partner and one coding for the hydrophobin part are combined in such a way that the desired protein is generated by gene expression of the combined nucleic acid sequence in a host organism. A preparation process of this kind is disclosed in our previous application DE 102005007480.4.

Host organisms (producer organisms) which may be suitable here for the preparation process mentioned are prokaryotes (including Archaea) or eukaryotes, particularly bacteria including halobacteria and methanococci, fungi, insect cells, plant cells and mammalian cells, particularly preferably Escherichia coli, Bacillus subtilis, Bacillus megaterium, Aspergillus oryzea, Aspergillus nidulans, Aspergillus niger, Pichia pastoris, Pseudomonas spec., lactobacilli, Hansenula polymorpha, Trichoderma reesei, SF9 (or related cells), and others.

The invention moreover relates to the use of expression constructs comprising, under the genetic control of regulatory nucleic acid sequences, a nucleic acid sequence coding for a polypeptide used according to the invention and also to vectors comprising at least one of these expression constructs.

Constructs used preferably comprise a promoter 5′ upstream of the particular coding sequence and a terminator sequence 3′ downstream and, if appropriate, further customary regulatory elements, in each case operatively linked to the coding sequence.

An “operative linkage” means the sequential arrangement of promoter, coding sequence, terminator and, if appropriate, further regulatory elements in such a way that each of the regulatory elements is able to fulfill its function as required in expressing the coding sequence.

Examples of operatively linkable sequences are targeting sequences and also enhancers, polyadenylation signals and the like. Other regulatory elements comprise selectable markers, amplification signals, origins of replication and the like. Suitable regulatory sequences are described, for example, in Goeddel, Gene Expression Technology: Methods in Enzymology 185, Academic Press, San Diego, Calif. (1990).

In addition to these regulatory sequences, the natural regulation of these sequences may still be present upstream of the actual structural genes and, if appropriate, may have been genetically altered in such a way that the natural regulation has been switched off and expression of the genes has been increased.

A preferred nucleic acid construct also advantageously comprises one or more of the previously mentioned enhancer sequences which are functionally linked to the promoter and which enable expression of the nucleic acid sequence to be increased. Additional advantageous sequences such as further regulatory elements or terminators may also be inserted at the 3′ end of the DNA sequences.

The nucleic acids may be present in the construct in one or more copies. The construct may also comprise additional markers such as antibiotic resistances or auxotrophy-complementing genes, if appropriate for the purpose of selecting said construct.

Regulatory sequences which are advantageous for the process are present, for example, in promoters such as the cos, tac, trp, tet, trp, tet, lpp, lac, lpp-lac, laclq-T7, T5, T3, gal, trc, ara, rhaP (rhaP_{BAD})SP6, lambda-PR or in the lambda-P promoter, which promoters are advantageously used in Gram-negative bacteria. Further advantageous regulatory sequences are present, for example, in the Gram-positive promoters amy and SPO2, in the yeast or fungal promoters ADC1, MFalpha, AC, P-60, CYC1, GAPDH, TEF, rp28, ADH.

It is also possible to use artificial promoters for regulation.

For the purpose of expression in a host organism, the nucleic acid construct is advantageously inserted into a vector such as a plasmid or a phage, for example, which enables the genes to be expressed optimally in the host. Vectors mean, in addition to plasmids and phages, also any other vectors known to the skilled worker, i.e., for example, viruses such as SV40, CMV, baculovirus and adenovirus, transposons, IS elements, phasmids, cosmids, and linear or circular DNA, and also the Agrobacterium system.

These vectors may be replicated autonomously in the host organism or replicated chromosomally. These vectors constitute a further embodiment of the invention. Examples of suitable plasmids are, in E. coli, pLG338, pACYC184, pBR322, pUC18, pUC19, pKC30, pRep4, pHS1, pKK223-3, pDHE19.2, pHS2, pPLc236, pMBL24, pLG200, pUR290, pIN-III″3-B1, tgt11 or pBdCl, in Streptomyces, pIJ101, pIJ364, pIJ702 or pIJ361, in Bacillus, pUB110, pC194 or pBD214, in Corynebacterium, pSA77 or pAJ667, in fungi, pALS1, pIL2 or pBB116, in yeasts, 2alpha, pAG-1, YEp6, YEp13 or pEMBLYe23, or, in plants, pLGV23, pGHlac+, pBIN19, pAK2004 or pDH51. Said plasmids are a small selection of the possible plasmids. Other plasmids are well known to the skilled worker and can be found, for example, in the book Cloning Vectors (Eds. Pouwels P. H. et al. Elsevier, Amsterdam-New York-Oxford, 1985, ISBN 0 444 904018).

For the purpose of expressing the other genes which are present, the nucleic acid construct advantageously also comprises 3′-terminal and/or 5′-terminal regulatory sequences for increasing expression, which are selected for optimal expression in dependence on the host organism and the gene or genes selected.

These regulatory sequences are intended to enable the genes and protein expression to be specifically expressed. Depending on the host organism, this may mean, for example, that the gene is expressed or overexpressed only after induction or that it is expressed and/or overexpressed immediately.

In this connection, the regulatory sequences or factors may preferably influence positively and thereby increase expression of the genes which have been introduced. Thus, the regulatory elements may advantageously be enhanced at the level of transcription by using strong transcription signals such as promoters and/or enhancers. However, in addition to this, it is also possible to enhance translation by improving the stability of the mRNA, for example.

In a further embodiment of the vector, the vector which comprises the nucleic acid construct of the invention or the nucleic acid of the invention may also advantageously be introduced into the microorganisms in the form of a linear DNA and be integrated into the genome of the host organism by way of heterologous or homologous recombination. This linear DNA may consist of a linearized vector such as a plasmid or only of the nucleic acid construct or the nucleic acid.

In order to express heterologous genes optimally in organisms, it is advantageous to alter the nucleic acid sequences in accordance with the specific codon usage employed in the organism. The codon usage can readily be determined with the aid of computer analyses of other known genes of the organism in question.

An expression cassette is prepared by fusing a suitable promoter to a suitable coding nucleotide sequence and to a terminator signal or polyadenylation signal. Common recombination and cloning techniques, as are described, for example, in T. Maniatis, E. F. Fritsch and J. Sambrook, Molecular Cloning: A Laboratory Manual, Cold Spring Harbor Laboratory, Cold Spring Harbor, N.Y. (1989) and also in T. J. Silhavy, M. L. Berman and L. W. Enquist, Experiments with Gene Fusions, Cold Spring Harbor Laboratory, Cold Spring Harbor, N.Y. (1984) and in Ausubel, F. M. et al., Current Protocols in Molecular Biology, Greene Publishing Assoc. and Wiley Interscience (1987), are used for this purpose.

In order to achieve expression in a suitable host organism, the recombinant nucleic acid construct or gene construct is advantageously inserted into a host-specific vector which enables the genes to be expressed optimally in the host. Vectors are well known to the skilled worker and may be found, for example, in “Cloning Vectors” (Pouwels P. H. et al., Eds., Elsevier, Amsterdam-New York-Oxford, 1985).

It is possible to prepare, with the aid of the vectors, recombinant microorganisms which are, for example, transformed with at least one vector and which may be used for producing the proteins used according to the invention. Advantageously, the above-described recombinant constructs of the invention are introduced into a suitable host system and expressed. In this connection, familiar cloning and transfection methods known to the skilled worker, such as, for example, coprecipitation, protoplast fusion, electroporation, retroviral transfection and the like, are preferably used in order to cause said nucleic acids to be expressed in the particular expression system. Suitable systems are described, for example, in Current Protocols in Molecular Biology, F. Ausubel et al., Eds., Wiley Interscience, New York 1997, or Sambrook et al. Molecular Cloning: A Laboratory Manual. 2nd edition, Cold Spring Harbor Laboratory, Cold Spring Harbor Laboratory Press, Cold Spring Harbor, N.Y., 1989.

It is also possible to prepare homologously recombined microorganisms. For this purpose, a vector which comprises at least one section of a gene to be used according to the invention or of a coding sequence in which, if appropriate, at least one amino acid deletion, amino acid addition or amino acid substitution has been introduced in order to modify, for example functionally disrupt, the sequence (knockout vector), is prepared.

The introduced sequence may, for example, also be a homolog from a related microorganism or be derived from a mammalian, yeast or insect source. Alternatively, the vector used for homologous recombination may be designed in such a way that the endogenous gene is, in the case of homologous recombination, mutated or otherwise altered but still encodes the functional protein (e.g. the upstream regulatory region may have been altered in such a way that expression of the endogenous protein is thereby altered). The altered section of the gene used according to the invention is in the homologous recombination vector. The construction of vectors which are suitable for homologous recombination is described, for example, in Thomas, K. R. and Capecchi, M. R. (1987) Cell 51:503.

Recombinant host organisms suitable for the nucleic acid used according to the invention or the nucleic acid construct are in principle any prokaryotic or eukaryotic organisms. Advantageously, microorganisms such as bacteria, fungi or yeasts are used as host organisms. Gram-positive or Gram-negative bacteria, preferably bacteria of the families Enterobacteriaceae, Pseudomonadaceae, Rhizobiaceae, Streptomycetaceae or Nocardiaceae, particularly preferably bacteria of the genera Escherichia, Pseudomonas, Streptomyces, Nocardia, Burkholderia, Salmonella, Agrobacterium or Rhodococcus, are advantageously used.

The organisms used in the process of preparing fusion proteins are, depending on the host organism, grown or cultured in a manner known to the skilled worker. Microorganisms are usually grown in a liquid medium which comprises a carbon source, usually in the form of sugars, a nitrogen source, usually in the form of organic nitrogen sources such as yeast extract or salts such as ammonium sulfate, trace elements such as iron salts, manganese salts and magnesium salts and, if appropriate, vitamins, at temperatures of between 0° C. and 100° C., preferably between 10° C. and 60° C., while being supplied with oxygen. In this connection, the pH of the nutrient liquid may or may not be kept at a fixed value, i.e. may or may not be regulated during cultivation. The cultivation may be carried out batchwise, semibatchwise or continuously. Nutrients may be initially introduced at the beginning of the fermentation or be fed in subsequently in a semicontinuous or continuous manner. The enzymes may be isolated from the organisms by the process described in the examples or be used for the reaction as a crude extract.

Proteins used according to the invention or functional, biologically active fragments thereof may be prepared using a recombinant process, with a protein-producing microorganism being cultured, expression of the proteins being induced if appropriate and said proteins being isolated from the culture. The proteins may also be produced in this way on an industrial scale if this is desired. The recombinant microorganism may be cultured and fermented by known methods. Bacteria may, for example, be propagated in TB medium or LB medium and at a temperature of from 20 to 40° C. and a pH of from 6 to 9. Suitable culturing conditions are described in detail, for example, in T. Maniatis, E. F. Fritsch and J. Sambrook, Molecular Cloning: A Laboratory Manual, Cold Spring Harbor Laboratory, Cold Spring Harbor, N.Y. (1989).

If the proteins used according to the invention are not secreted into the culture medium, the cells are then disrupted and the product is obtained from the lysate by known protein isolation processes. The cells may be disrupted, as desired, by means of high-frequency ultrasound, by means of high pressure, such as, for example, in a French pressure cell, by means of osmolysis, by the action of detergents, lytic enzymes or organic solvents, by means of homogenizers or by a combination of two or more of the processes listed.

The proteins used according to the invention may be purified using known chromatographic methods such as molecular sieve chromatography (gel filtration), for example Q Sepharose chromatography, ion exchange chromatography and hydrophobic chromatography, and also using other customary methods such as ultrafiltration, crystallization, salting-out, dialysis and native gel electrophoresis. Suitable processes are described, for example, in Cooper, F. G., Biochemische Arbeitsmethoden, Verlag Walter de Gruyter, Berlin, New York or in Scopes, R., Protein Purification, Springer Verlag, New York, Heidelberg, Berlin.

It may be advantageous to isolate the recombinant protein by using vector systems or oligonucleotides which extend the cDNA by particular nucleotide sequences and thereby code for altered proteins or fusion proteins which are used, for example, to simplify purification. Examples of suitable modifications of this kind are “tags” acting as anchors, such as the modification known as the hexa-histidine anchor, or epitopes which can be recognized as antigens by antibodies (described, for example, in Harlow, E. and Lane, D., 1988, Antibodies: A Laboratory Manual. Cold Spring Harbor (N.Y.) Press). Other suitable tags are, for example, HA, calmodulin-BD, GST, MBD; chitin-BD, streptavidin-BD-avi-tag, Flag-tag, T7 etc. These anchors may be used for attaching the proteins to a solid support such as a polymer matrix, for example, which may, for example, be packed in a chromatography column, or may be used on a microtiter plate or on another support. The corresponding purification protocols can be obtained from the commercial affinity tag suppliers.

The proteins prepared as described may be used either directly as fusion proteins or, after cleaving off and removing the fusion partner, as “pure” hydrophobins.

If the fusion partner is intended to be removed, it is recommended to incorporate a potential cleavage site (specific recognition site for proteases) into the fusion protein between the hydrophobin part and the fusion partner part. Suitable cleavage sites are in particular those peptide sequences which otherwise occur neither in the hydrophobin part nor in the fusion partner part, which can be readily determined by means of bioinformatics tools. Particularly suitable are, for example, BrCN cleavage on methionine or protease-mediated cleavage with factor Xa, enterokinase cleavage, thrombin, TEV cleavage (tobacco etch virus protease).

The expandable or expanded, thermoplastic polymer particles may be coated before or after foaming, for example by applying hydrophobin in a drum, using a Lödige paddle mixer, or by contacting the surface of said polymer particles with a hydrophobin-containing solution, for example by dipping or spraying. The preparation by way of extruding a melt containing blowing agents may also involve adding the hydrophobin to the water circuit of the underwater pelletizer.

The expandable or expanded, thermoplastic polymer particles are preferably coated using an aqueous solution with a concentration of from 1 to 100 g/l hydrophobin and a pH in the range of 5 to 9. The hydrophobin-containing solution is normally applied at a temperature in the range of 0 to 140° C., preferably in the range of 30 to 80° C.

The expandable and expanded, thermoplastic polymer particles according to the invention are antistatic, exhibit a low tendency of caking during foaming, but good fusion when foamed to give moldings.

### EXAMPLES

### Example 1

### Preliminary Work for the Cloning of Yaad-His₆/YaaE-His₆

A polymerase chain reaction was carried out with the aid of the oligonucleotides Hal570 and Hal571 (Hal 572/Hal 573). The template DNA used was genomic DNA of the bacterium Bacillus subtilis. The PCR fragment obtained comprised the coding sequence of the Bacillus subtilis yaaD/yaaE gene and, at their termini, in each case an NcoI and, respectively, BgIII restriction cleavage site. The PCR fragment was purified and cut with the restriction endonucleases NcoI and BgIII. This DNA fragment was used as insert and cloned into the vector pQE60 from Qiagen, which had previously been linearized with the restriction endonucleases NcoI and BgIII. The vectors thus obtained, pQE60YAAD#2/pQE60YaaE#5, may be used for expressing proteins consisting of YAAD::HIS₆ and YAAE::HIS₆, respectively.

HaI570: gcgcgcccatggctcaaacaggtactga
HaI571: gcagatctccagccgcgttcttgcatac
HaI572: ggccatgggattaacaataggtgtactagg
HaI573: gcagatcttacaagtgccttttgcttatattcc

### Example 2

### Cloning of Yaad Hydrophobin DewA-His₆

A polymerase chain reaction was carried out with the oligonucleotide KaM 416 and KaM 417. The template DNA used was genomic DNA of the mold Aspergillus nidulans. The PCR fragment obtained comprised the coding sequence of the hydrophobin gene dewA and an N-terminal factor Xa proteinase cleavage site. The PCR fragment was purified and cut with the restriction endonuclease BamHI. This DNA fragment was used as insert and cloned into the pQE60YAAD#2 vector previously linearized with the restriction endonuclease BgIII.

The vector thus obtained, #508, may be used for expressing a fusion protein consisting of YAAD::Xa::dewA::HIS₆.

KaM416:
GCAGCCCATCAGGGATCCCTCAGCCTTGGTACCAGCGC
KaM417:
CCCGTAGCTAGTGGATCCATTGAAGGCCGCATGAAGTTCTCCGTC-
TCCGC

### Example 3

### Cloning of Yaad Hydrophobin RodA-His₆

The plasmid #513 was cloned analogously to plasmid #508, using the oligonucleotides KaM 434 and KaM 435.

KaM434:
GCTAAGCGGATCCATTGAAGGCCGCATGAAGTTCTCCATTGCTGC
KaM435:
CCAATGGGGATCCGAGGATGGAGCCAAGGG

### Example 4

### Cloning of Yaad Hydrophobin BASF1-His₆

The plasmid #507 was cloned analogously to plasmid #508, using the oligonucleotides KaM 417 and KaM 418. The template DNA employed was an artificially synthesized DNA sequence—hydrophobin BASF1—(see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 5

### Cloning of the Yaad Hydrophobin BASF2-His₆

The plasmid #506 was cloned analogously to plasmid #508, using the oligonucleotides KaM 417 and KaM 418. The template DNA employed was an artificially synthesized DNA sequence—hydrophobin BASF2 (see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 6

### Cloning of the Yaad Hydrophobin SC3-His₆

The plasmid #526 was cloned analogously to plasmid #508, using the oligonucleotides KaM464 and KaM465. The template DNA employed was Schyzophyllum commune cDNA (see appendix).

KaM464: CGTTAAGGATCCGAGGATGTTGATGGGGGTGC
KaM465: GCTAACAGATCTATGTTCGCCCGTCTCCCCGTCGT

### Example 7

### Fermentation of the Recombinant E. coli Strain Yaad Hydrophobin DewA-His₆

Inoculation of 3 ml of LB liquid medium with an E. coli strain expressing yaad hydrophobin DewA-His₆ in 15 ml Greiner tubes. Incubation at 37° C. on a shaker at 200 rpm at 37° C. for 8 h. In each case 21 l Erlenmeyer flasks with baffles and 250 ml of LB medium (+100 μg/ml ampicillin) are inoculated with 1 ml of preculture and incubated on a shaker at 180 rpm at 37° C. for 9 h. Inoculate 13.5 l of LM medium (+100 μg/ml ampicillin) with 0.5 l of preculture (OD₆₀₀ₙₘ 1:10 measured against H₂O) in a 20 l fermenter. Addition of 140 ml of 100 mM IPTG at an OD₆₀₀ₙₘ of ˜3.5. After 3 h, cool fermenter to 10° C. and remove fermentation broth by centrifugation. Use cell pellet for further purification.

### Example 8

### Purification of the Recombinant Hydrophobin Fusion Protein (Purification of Hydrophobin Fusion Proteins Possessing a C-Terminal His6 Tag)

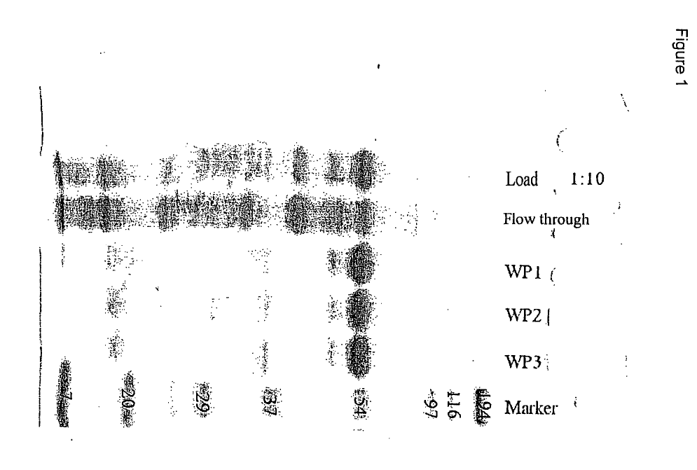

100 g of cell pellet (100-500 mg of hydrophobin) are made up with 50 mM sodium phosphate buffer, pH 7.5, to a total volume of 200 ml and resuspended. The suspension is treated with an Ultraturrax type T25 (Janke and Kunkel; IKA-Labortechnik) for 10 minutes and subsequently, for the purposes of degrading the nucleic acids, incubated with 500 units of benzonase (Merck, Darmstadt; order No. 1.01697.0001) at room temperature for 1 hour. Prior to cell disruption, a filtration is carried out using a glass cartridge (P1). For the purposes of disrupting the cells and of shearing of the remaining genomic DNA, two homogenizer runs are carried out at 1500 bar (Microfluidizer M-110EH; Microfluidics Corp.). The homogenate is centrifuged (Sorvall RC-5B, GSA Rotor, 250 ml centrifuge beaker, 60 minutes, 4° C., 12 000 rpm, 23 000 g), the supernatant is put on ice and the pellet is resuspended in 100 ml of sodium phosphate buffer, pH 7.5. Centrifugation and resuspension are repeated three times, the sodium phosphate buffer containing 1% SDS at the third repeat. After resuspension, the solution is stirred for one hour, followed by a final centrifugation (Sorvall RC-5B, GSA Rotor, 250 ml centrifuge beaker, 60 minutes, 4° C., 12 000 rpm, 23 000 g). According to SDS-PAGE analysis, the hydrophobin is present in the supernatant after the final centrifugation (FIG. 1). The experiments show that hydrophobin is present in the corresponding E. coli cells probably in the form of inclusion bodies. 50 ml of the hydrophobin-containing supernatant are applied to a 50 ml nickel-Sepharose High Performance 17-5268-02 column (Amersham) equilibrated with 50 mM Tris-Cl buffer, pH 8.0. The column is washed with 50 mM Tris-Cl buffer, pH 8.0, and the hydrophobin is subsequently eluted with 50 mM Tris-Cl buffer, pH 8.0, comprising 200 mM imidazole. For the purpose of removing the imidazole, the solution is dialyzed against 50 mM Tris-Cl buffer, pH 8.0.

FIG. 1 depicts the purification of the hydrophobin prepared:

Lane 1: solution applied to nickel-Sepharose column (1:10 dilution)

Lane 2: flow-through=eluate of washing step

Lanes 3-5: OD 280 peaks of elution fractions

The hydrophobin of FIG. 1 has a molecular weight of approx. 53 kD. Some of the smaller bands represent degradation products of hydrophobin.

### Example 9

### Performance Testing; Characterization of the Hydrophobin by Changing the Contact Angle of a Water Droplet on Glass

### Substrate:

Glass (window glass, Süddeutsche Glas, Mannheim, Germany):
Hydrophobin concentration: 100 μg/mL
Incubation of glass slides overnight (temperature 80° C.) in 50 mM sodium acetate pH 4+0.1% polyoxyethylene (20) sorbitan monolaurate (Tween® 20)
followed by coating, washing in distilled water
followed by incubation: 10 min/80° C./1% sodium dodecyl sulfate (SDS) solution in dist. water
washing in dist. water

The samples are dried in air and the contact angle (in degrees) of a droplet of 5 μl of water is determined at room temperature.

The contact angle was measured on a Dataphysics Contact Angle System OCA 15+ instrument, software SCA 20.2.0. (November 2002). The measurement was carried out according to the manufacturer's instructions.

Untreated glass resulted in a contact angle of 30±5°; a coating with the functional hydrophobin according to Example 8 (yaad-dewA-his₆) resulted in contact angles of 75±5°.

### Examples 10 and 11

### Coating of EPS Beads with Hydrophobin pQE60+YaaD+Xa+dewA+HIS

Coating agent:

Aqueous solution of hydrophobin pQE60+YaaD+Xa+dewA+HIS6 (SEQ ID NO: 19), pretreated according to example 8 (50 mM NaH2PO4, pH 7.5, concentration of hydrophobin: 6.08 g/l).

Uncoated, expandable polystyrene (EPS) beads with a bead size in the range of 0.7 to 1.0 mm, prepared by means of suspension polymerization (Styropor® F 315/N), were dried and coated as follows:

50 g of EPS beads were weighed into a 500 ml glass with screw cap, admixed with 10 ml and 20 ml, respectively, of the hydrophobin solution and agitated on a roller mixer at room temperature for 24 hours. The hydrophobin-coated EPS beads were then laid out on filter paper and dried at room temperature for 5 hours.

### Comparative Experiment V1

Example 10 was repeated, but with the difference that 10 ml of distilled water were used instead of the hydrophobin solution.

The coated EPS beads of examples 10 and 11 and of the comparative experiment were in each case prefoamed in a pre-expander (Rauscher) at 100° C. for 2 minutes to give polystyrene foam beads and fused to moldings after 3 days of storage. The moldings were evaluated for the quality of the fusion by breaking them in half after 2 days of storage.

The antistatic properties were evaluated by measuring the surface resistance of the prefoamed and dried polystyrene foam beads.

TABLE 1

| | | Caking of pre- | | Antistatics |
|---|---|---|---|---|
| | Hydrophobin | foamed EPS | | (surface |
| Example | solution | beads | Fusion | resistance) |
| 10 | 10 ml | little | very good | <10¹⁰ ohm |
| 11 | 20 ml | little | good | |
| V1 | 0 ml | strong | poor | >10¹⁴ ohm |

Assignment of sequence names to DNA and polypeptide sequences in the sequence listing

| | |
|---|---|
| dewA DNA and polypeptide sequences | SEQ ID NO: 1 |
| dewA polypeptide sequence | SEQ ID NO: 2 |
| rodA DNA and polypeptide sequences | SEQ ID NO: 3 |
| rodA polypeptide sequence | SEQ ID NO: 4 |
| hypA DNA and polypeptide sequences | SEQ ID NO: 5 |
| hypA polypeptide sequence | SEQ ID NO: 6 |
| hypB DNA and polypeptide sequences | SEQ ID NO: 7 |
| hypB polypeptide sequence | SEQ ID NO: 8 |
| sc3 DNA and polypeptide sequences | SEQ ID NO: 9 |
| sc3 polypeptide sequence | SEQ ID NO: 10 |
| basf1 DNA and polypeptide sequences | SEQ ID NO: 11 |
| basf1 polypeptide sequence | SEQ ID NO: 12 |
| basf2 DNA and polypeptide sequences | SEQ ID NO: 13 |
| basf2 polypeptide sequence | SEQ ID NO: 14 |
| yaad DNA and polypeptide sequences | SEQ ID NO: 15 |
| yaad polypeptide sequence | SEQ ID NO: 16 |
| yaae DNA and polypeptide sequences | SEQ ID NO: 17 |
| yaae polypeptide sequence | SEQ ID NO: 18 |
| yaad-Xa-dewA-his₆ DNA and polypeptide sequences | SEQ ID NO: 19 |
| yaad-Xa-dewA-his polypeptide sequence | SEQ ID NO: 20 |
| yaad-Xa-rodA-his DNA and polypeptide sequences | SEQ ID NO: 21 |
| yaad-Xa-rodA-his polypeptide sequence | SEQ ID NO: 22 |
| yaad-Xa-basf1-his DNA and polypeptide sequences | SEQ ID NO: 23 |
| yaad-Xa-basf1-his polypeptide sequence | SEQ ID NO: 24 |

1. An expandable or expanded, thermoplastic polymer particle with a coating comprising hydrophobin.

2. The expandable or expanded, thermoplastic polymer particle according to claim 1, wherein the coating comprises from 1 to 5000 ppm of hydrophobin, based on the thermoplastic polymer.

3. The expandable or expanded, thermoplastic polymer particle according to claim 1, wherein the thermoplastic polymer consists of polystyrene or polyolefin.

4. The expandable or expanded, thermoplastic polymer particle according to claim 1, which has an average particle diameter in the range of 0.05 to 5 mm.

5. The expandable or expanded, thermoplastic polymer particle according to claim 1, wherein the coating comprises a hydrophobin of the general formula (II)
Xₙ-C¹-X₃₋₂₅-C²-X₀₋₂-C³-X₅₋₅₀-C⁴-X₂₋₃₅-C⁵-X₂₋₁₅-C⁶-X₀₋₂-C⁷-X₃₋₃₅-C⁸-Xₘ (II),
where X is any of the 20 naturally occurring amino acids,
n and m are numbers between 0 and 500, and
C is cysteine.

6. The expandable or expanded, thermoplastic polymer particle according to claim 4, wherein the coating comprises a hydrophobin of the general formula (III)
Xₙ-C¹-X₅₋₉-C²-C³-X₁₁₋₃₉-C⁴-X₂₋₂₃-C⁵-X₅₋₉-C⁶-C⁷-X₆₋₁₈-C⁸-Xₘ (II),

7. The expandable or expanded, thermoplastic polymer particle according to claim 1, wherein the coating comprises a dewA, rodA, hjypA, hypB, sc3, basf1 or basf2 type hydrophobin.

8. A process for coating expandable or expanded, thermoplastic polymer particles, wherein the surface of the polymer particles is contacted with a hydrophobin-containing solution.

9. The process according to claim 1, wherein the hydrophobin-containing solution used is an aqueous solution with a hydrophobin concentration of from 1 to 100 g/l and a pH in the range of 5 to 9.

10. The process according to claim 1, wherein the surface is contacted with the hydrophobin-containing solution at a temperature in the range of 0 to 140° C.


SEQUENCE LISTING (35 sequences)

SEQ ID NO: 1 - DNA, 405 bp, Aspergillus nidulans
  CDS (1)..(405): basf-dewA hydrophobin
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
  basf-dewA hydrophobin
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471): basf-rodA hydrophobin
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
  basf-rodA hydrophobin
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Artificial Sequence
  CDS (1)..(336): Chemically synthesized polynucleotide basf-hypA
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Artificial Sequence
  basf-hypA from chemically synthesized polynucleotide
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Artificial Sequence
  CDS (1)..(357): chemically synthesized polynucleotide basf-hypB
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Artificial Sequence
  basf-hypB from chemically synthesized polynucleotide
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schyzophyllum commune
  CDS (1)..(408): basf-sc3 hydrophobin, cDNA template
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schyzophyllum commune
  basf-sc3 hydrophobin, cDNA
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  CDS (1)..(483): chemically synthesized polynucleotide basf- BASF1
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  basf-BASF1 from chemically synthesized polynucleotide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  CDS (1)..(465): chemically synthesized polynucleotide basf- BASF2
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  basf-BASF2 from chemically synthesized polynucleotide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882): basf-yaad yaaD
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
  basf-yaad yaaD
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591): basf-yaae yaaE with Gly insert at position 2
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
  basf-yaae yaaE with Gly insert at position 2
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  CDS (1)..(1329): basf-yaad-Xa-dewA-his fusion of Bacillus subtilis yaaD and N-terminal factor Xa proteinase cleavage site and Aspergillus nidulans hydrophobin dewA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  basf-yaad-Xa-dewA-his fusion of Bacillus subtilis yaaD and N-terminal factor Xa proteinase cleavage site and Aspergillus nidulans hydrophobin dewA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  CDS (1)..(1395): basf-yaad-Xa-rodA-his fusion of Bacillus subtilis yaaD and N-terminal factor Xa proteinase cleavage site and Aspergillus nidulans hydrophobin rodA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  basf-yaad-Xa-rodA-his fusion of Bacillus subtilis yaaD and N-terminal factor Xa proteinase cleavage site and Aspergillus nidulans hydrophobin rodA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  CDS (1)..(1407): basf-yaad-Xa-BASF1-his fusion of Bacillus subtilis yaaD and N-terminal factor Xa proteinase cleavage site and artificial hydrophobin BASF1; BASF1 from chemically synthesized polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  basf-yaad-Xa-BASF1-his fusion of Bacillus subtilis yaaD and N-terminal factor Xa proteinase cleavage site and artificial hydrophobin BASF1; BASF1 from chemically synthesized polynucleotide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 28 bp, Artificial Sequence
  Chemically synthesized Hal570 primer
gcgcgcccatggctcaaacaggtactga

SEQ ID NO: 26 - DNA, 28 bp, Artificial Sequence
  Chemically synthesized Hal571 primer
gcagatctccagccgcgttcttgcatac

SEQ ID NO: 27 - DNA, 30 bp, Artificial Sequence
  Chemically synthesized Hal572 primer
ggccatgggattaacaataggtgtactagg

SEQ ID NO: 28 - DNA, 33 bp, Artificial Sequence
  Chemically synthesized Hal573 primer
gcagatcttacaagtgccttttgcttatattcc

SEQ ID NO: 29 - DNA, 38 bp, Artificial Sequence
  Chemically synthesized KaM416 primer
gcagcccatcagggatccctcagccttggtaccagcgc

SEQ ID NO: 30 - DNA, 50 bp, Artificial Sequence
  Chemically synthesized KaM417 primer
cccgtagctagtggatccattgaaggccgcatgaagttctccgtctccgc

SEQ ID NO: 31 - DNA, 45 bp, Artificial Sequence
  Chemically synthesized KaM434 primer
gctaagcggatccattgaaggccgcatgaagttctccattgctgc

SEQ ID NO: 32 - DNA, 30 bp, Artificial Sequence
  Chemically synthesized KaM435 primer
ccaatggggatccgaggatggagccaaggg

SEQ ID NO: 33 - DNA, 38 bp, Artificial Sequence
  Chemically synthesized KaM418 primer
ctgccattcaggggatcccatatggaggagggagacag

SEQ ID NO: 34 - DNA, 32 bp, Artificial Sequence
  Chemically synthesized KaM464 primer
cgttaaggatccgaggatgttgatgggggtgc

SEQ ID NO: 35 - DNA, 35 bp, Artificial Sequence
  Chemically synthesized KaM465 primer
gctaacagatctatgttcgcccgtctccccgtcgt